(19) United States
(12) Patent Application Publication
(10) Pub. No.: US 2026/0170636 A1
(43) Pub. Date: Jun. 18, 2026

(54) METHOD AND APPARATUS FOR DETECTING DARK SPOTS ON END FACE OF OPTICAL FIBER IMAGE TRANSMISSION ELEMENT

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Peng Jiao, Beijing (CN); Yuwen Xing, Beijing (CN); Yajie Du, Beijing (CN); Danqi Zhao, Beijing (CN); Yan Duan, Beijing (CN); Rui Zhang, Beijing (CN); Bo Liu, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,544

(22) Filed: Aug. 21, 2025

(30) Foreign Application Priority Data
Dec. 16, 2024 (CN) 2024118519079

(51) Int. Cl. G06T 7/00; G06T 7/73

(52) U.S. Cl. CPC G06T 7/001; G06T 7/73; G06T 2207/30242

(57) ABSTRACT

A method for detecting dark spots on an end face of an optical fiber image transmission element includes: acquiring a plurality of end face images corresponding to an optical fiber image transmission element to be detected; performing secondary diffusion processing on each of the end face images according to a plurality of preset diffusion matrices to generate a secondary diffusion image corresponding to each of the end face images; and determining a number of dark spots comprised in each of the end face images and an area value corresponding to each of the dark spots according to a number of closed regions comprised in each of the secondary diffusion images and a number of pixel points comprised in each of the closed regions.

### TECHNICAL FIELD

The present application relates to the technical field of detection of optical fiber image transmission elements, and particularly to a method and an apparatus for detecting dark spots on an end face of an optical fiber image transmission element.

### BACKGROUND

Optical fiber image transmission elements (such as fiber optical plates, fiber optical inverters, fiber optical tapers, etc.) are fiber optic material bundles composed of tens of thousands to hundreds of thousands of micrometer-scale optical fibers. Based on the principle of total reflection at the interface, images may be transmitted from one end of the optical fiber image transmission element to the other end. Optical fiber image transmission elements are widely used in optoelectronic devices such as image intensifiers, image intensifier-type CCDs, and particle detectors. Among them, dark spots are a type of end-face optical defect caused by physical and chemical effects during the production and processing of optical fiber image transmission elements. Visually, they mainly appear as shadow spots on the end face of the optical fiber image transmission element. The area of a dark spot is usually 20-250 square micrometers, which is equivalent to the area of 1-10 mono fibers. The number of dark spots on the end face of the optical fiber image transmission element and the area of each dark spot are important indicators for evaluating the production quality of the optical fiber image transmission element.

At present, inspectors usually observe the end face of the optical fiber image transmission element under a microscope and detect the number of dark spots on the end face of the optical fiber image transmission element and the area of each dark spot by means of manual identification. However, the manual identification method for dark spot detection of optical fiber image transmission elements by inspectors completely relies on the work experience and working state of the inspectors. When the inspectors have insufficient work experience or are in a poor working state, they cannot accurately detect the number of dark spots on the end face of the optical fiber image transmission element and the area of each dark spot. Therefore, the detection accuracy of manual identification for dark spot detection of optical fiber image transmission elements is relatively low.

### SUMMARY OF THE INVENTION

Embodiments of the present application provide a method and an apparatus for detecting dark spots on an end face of an optical fiber image transmission element, the main purpose of which is to improve the detection accuracy of dark spot detection for optical fiber image transmission elements.

To solve the above technical problems, the embodiments of the present application provide the following technical solutions:
In a first aspect, the present application provides a method for detecting dark spots on an end face of an optical fiber image transmission element, the method including:
acquiring a plurality of end face images corresponding to an optical fiber image transmission element to be detected, wherein the plurality of end face images are images obtained by photographing different regions of the end face of the optical fiber image transmission element to be detected with a photographing device;
performing secondary diffusion processing on each of the end face images according to a plurality of preset diffusion matrices to generate a secondary diffusion image corresponding to each of the end face images, wherein the secondary diffusion image includes a plurality of closed regions; and
determining a number of dark spots comprised in each of the end face images and an area value corresponding to each of the dark spots according to a number of closed regions comprised in each of the secondary diffusion images and a number of pixel points comprised in each of the closed regions.

In a second aspect, the present application also provides an apparatus for detecting dark spots on an end face of an optical fiber image transmission element, the apparatus including:
an acquisition unit configured to, acquire a plurality of end face images corresponding to a optical fiber image transmission element to be detected, wherein the plurality of end face images are images obtained by photographing different regions of the end face of the optical fiber image transmission element to be detected with a photographing device;
a first processing unit configured to, perform secondary diffusion processing on each of the end face images according to a plurality of preset diffusion matrices to generate a secondary diffusion image corresponding to each of the end face images, wherein the secondary diffusion image includes a plurality of closed regions; and
a first determination unit configured to, determine the number of dark spots comprised in each of the end face images and an area value corresponding to each of the dark spots according to the number of closed regions comprised in each of the secondary diffusion images and the number of pixel points comprised in each of the closed regions.

In a third aspect, an embodiment of the present application provides a storage medium, the storage medium includes a stored program, wherein when the program is run, it controls a device in which the storage medium is located to execute the method for detecting dark spots on an end face of an optical fiber image transmission element according to the first aspect.

In a fourth aspect, an embodiment of the present application provides an apparatus for detecting dark spots on an end face of an optical fiber image transmission element, the apparatus including a storage medium; and one or more processors, wherein the storage medium is coupled to the processors, and the processors are configured to execute program instructions stored in the storage medium; and when the program instructions are run, they execute the method for detecting dark spots on an end face of an optical fiber image transmission element according to the first aspect.

By virtue of the above technical solutions, the technical solutions provided in the present application have at least the following advantages:
The present application provides a method and an apparatus for detecting dark spots on an end face of an optical fiber image transmission element. In the present application, after inspectors capture a plurality of end face images corresponding to an optical fiber image transmission element to be detected using a photographing device and store the plurality of end face images corresponding to the optical fiber image transmission element to be detected in the local storage space of a target terminal device, a dark spot detection application program may acquire the plurality of end face images corresponding to the optical fiber image transmission element to be detected from the local storage space of the target terminal device, and perform secondary diffusion processing on each end face image according to a plurality of preset diffusion matrices to generate a secondary diffusion image corresponding to each end face image. For any end face image, the corresponding secondary diffusion image includes a plurality of closed regions, and each closed region corresponds to a dark spot. In addition, the number of dark spots included in each end face image and the area value corresponding to each dark spot are determined according to the number of closed regions included in each secondary diffusion image and the number of pixel points included in each closed region. In the present application, inspectors only need to capture a plurality of end face images corresponding to the optical fiber image transmission element to be detected using the photographing device, and the dark spot detection application program may determine the number of dark spots included in each end face image and the area value corresponding to each dark spot, as well as determine the number of dark spots on the end face of the optical fiber image transmission element to be detected and the area of each dark spot. The entire process does not require the intervention of inspectors, thus being independent of the work experience and working state of the inspectors, and may improve the detection accuracy of dark spot detection for optical fiber image transmission elements.

The above description is merely an overview of the technical solutions of the present application. To understand the technical means of the present application more clearly and implement them in accordance with the content of the specification, and to make the above and other objectives, features, and advantages of the present application more comprehensible, specific implementations of the present application are elaborated below.

### BRIEF DESCRIPTION OF THE DRAWINGS

By referring to the following detailed description with reference to the accompanying drawings, the above and other objectives, features, and advantages of the exemplary embodiments of the present application will become easily understandable. In the drawings, several embodiments of the present application are shown in an exemplary rather than restrictive manner, and the same or corresponding reference numerals denote the same or corresponding parts, wherein:

FIG. 1 illustrates a flowchart of a method for detecting dark spots on an end face of an optical fiber image transmission element provided by an embodiment of the present application;

FIG. 2 illustrates a flowchart of another method for detecting dark spots on an end face of an optical fiber image transmission element provided by an embodiment of the present application;

FIG. 3 illustrates a block diagram of a configuration of an apparatus for detecting dark spots on an end face of an optical fiber image transmission element provided by an embodiment of the present application; and

FIG. 4 illustrates a block diagram of a configuration of another apparatus for detecting dark spots on an end face of an optical fiber image transmission element provided by an embodiment of the present application.

### DETAILED DESCRIPTION OF SPECIFIC EMBODIMENTS

The exemplary embodiments of the present application will now be described in more details with reference to the accompanying drawings. While the drawings illustrate exemplary embodiments of the present application, it should be understood that the present application may be implemented in various forms and should not be limited by the embodiments set forth herein. Rather, these embodiments are provided to enable a more thorough understanding of the present application and to fully convey the scope of the present application to those skilled in the art.

Furthermore, the terms “first”, “second”, and similar terms configured in the present application do not denote any order, quantity, or importance, but are merely configured to distinguish different components.

It should be noted that unless otherwise specified, technical terms or scientific terms configured in the present application shall have the ordinary meaning as understood by those skilled in the art to which the present application pertains.

Currently, inspectors usually observe the end face of the optical fiber image transmission element under a microscope and detect the number of dark spots on the end face of the optical fiber image transmission element and the area of each dark spot through manual identification. However, the manual identification method for dark spot detection of optical fiber image transmission elements by inspectors completely relies on the work experience and working state of the inspectors. When the inspectors have insufficient work experience or are in a poor working state, they cannot accurately detect the number of dark spots on the end face of the optical fiber image transmission element and the area of each dark spot. Therefore, the detection accuracy of manual identification for dark spot detection of optical fiber image transmission elements is relatively low.

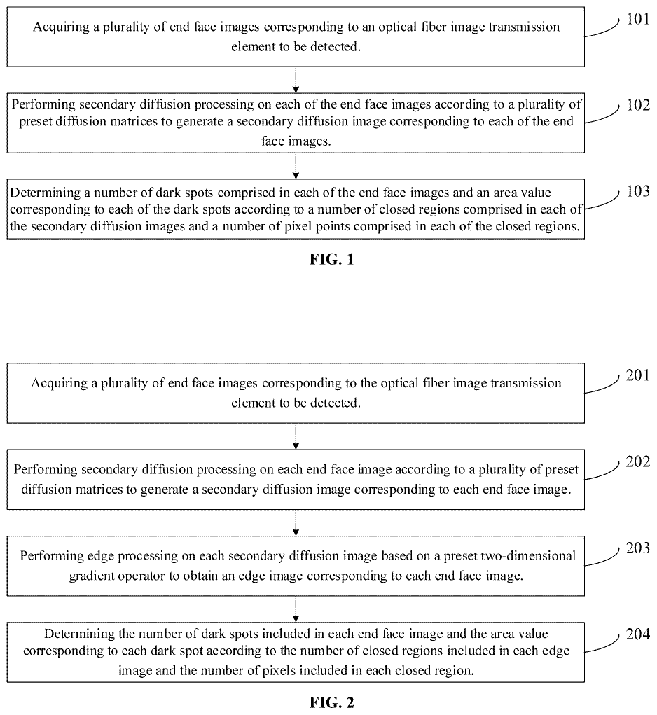

Therefore, in order to improve the detection accuracy of dark spot detection for optical fiber image transmission elements, an embodiment of the present application provides a method for detecting dark spots on an end face of an optical fiber image transmission element. As shown in FIG. 1, the method includes at least steps 101-103.

101. Acquiring a plurality of end face images corresponding to an optical fiber image transmission element to be detected.

Herein, inspectors may divide the end face of the optical fiber image transmission element to be detected into a plurality of regions, and use a photographing device to separately capture end face images corresponding to each region, so as to obtain a plurality of end face images corresponding to the optical fiber image transmission element to be detected. At this moment, the captured a plurality of end face images completely cover the end face of the optical fiber image transmission element to be detected. Inspectors may also take the center point of the end face of the optical fiber image transmission element to be detected as the origin, select a plurality of regions on the end face of the optical fiber image transmission element to be detected, and use the photographing device to separately capture end face images corresponding to each region, so as to obtain a plurality of end face images corresponding to the optical fiber image transmission element to be detected. At this moment, the captured a plurality of end face images partially cover the end face of the optical fiber image transmission element to be detected, but the present application is not limited thereto.

In the embodiment of the present application, the execution subject in each step is a dark spot detection application program running in a target terminal device, wherein the target terminal device may be, but is not limited to: a computer, a tablet computer, a notebook computer, and the like.

Herein, the photographing device is electrically connected to the target terminal device. After the photographing device captures the plurality of end face images corresponding to the optical fiber image transmission element to be detected, it may send the plurality of end face images corresponding to the optical fiber image transmission element to be detected to the target terminal device, and the target terminal device may store the plurality of end face images corresponding to the optical fiber image transmission element to be detected in the local storage space. When it is necessary to perform dark spot detection on the optical fiber image transmission element to be detected, the dark spot detection application program may acquire the plurality of end face images corresponding to the optical fiber image transmission element to be detected from the local storage space of the target terminal device.

It should be noted that the photographing device includes an industrial camera and a microscope, and the magnification of the microscope may be, but is not limited to, 20x, 30x, 40x, or 50x, etc. The camera chip pitch and pixel pitch of the industrial camera are determined according to the diameter of the mono fiber corresponding to the optical fiber image transmission element to be detected, the magnification of the microscope, and preset rules. For example, the preset rules are as follows: (1) The diameter of each mono fiber included in the optical fiber image transmission element to be detected occupies at least 25 pixels in the end face image; (2) The larger the field of view of the photographing device, the better; (3) The budget cost of the photographing device is A, the magnification of the microscope is 20x, and the diameter of the mono fiber corresponding to the optical fiber image transmission element to be detected is 5 microns. Therefore, the pitch (side length) of each pixel in the end face image should be less than 0.2 microns (5 microns divided by 25). The pitch (side length) of each pixel in the end face image is the pixel pitch of the industrial camera divided by the magnification. Therefore, the pixel pitch of the industrial camera needs to be less than 4 microns. The field of view of the photographing device is equal to the camera chip pitch of the industrial camera divided by the magnification of the microscope. Since the magnification of the microscope is fixed, the larger the camera chip pitch of the industrial camera, the larger the field of view of the photographing device. However, the larger the camera chip pitch of the industrial camera, the higher the cost. Therefore, it is necessary to select a larger camera chip pitch under the condition that the budget cost of the photographing device is less than or equal to A.

102. Performing secondary diffusion processing on each of the end face images according to a plurality of preset diffusion matrices to generate a secondary diffusion image corresponding to each of the end face images.

Herein, the plurality of preset diffusion matrices have different pitches. For any preset diffusion matrix, the preset diffusion matrix includes a central element, a plurality of elements to be diffused, and a plurality of other elements. For example, the plurality of preset diffusion matrices are a first preset diffusion matrix, a second preset diffusion matrix, a third preset diffusion matrix, etc. The first preset diffusion matrix is a 3×4 matrix, and the first preset diffusion matrix is specifically:
C B B C
B A B B
C B B C
Or
C B B C
B B A B
C B B C

The second preset diffusion matrix is a 5×7 matrix, and the second preset diffusion matrix is specifically:
C C B B B C C
C B B B B B C
B B B A B B B
C B B B B B C
C C B B B C C

The third preset diffusion matrix is a 7×10 matrix, and the third preset diffusion matrix is specifically:
C C C B B B B C C C
C C B B B B B B C C
C B B B B B B B B C
B B B B A B B B B B
C B B B B B B B B C
C C B B B B B B C C
C C C B B B B C C C
Or
C C C B B B B C C C
C C B B B B B B C C
C B B B B B B B B C
B B B B B A B B B B
C B B B B B B B B C
C C B B B B B B C C
C C C B B B B C C C

Herein, A is the central element, B is the element to be diffused, and C is the other element.

Herein, for any mono fiber included in the optical fiber image transmission element to be detected, the mono fiber includes core glass and clad glass. The core glass is cylindrical, the clad glass wraps around the outer surface of the core glass, the end face of the core glass is circular, the end face of the clad glass is annular, and the ratio of the diameter of the core glass to the diameter of the mono fiber is usually 5:6.

Since the core glass in the mono fiber emits light while the clad glass does not, for a normally luminous mono fiber, in the end face image, the grayscale value of the pixel corresponding to the core glass is higher than that of the pixel corresponding to the clad glass. As the dark spots on the surface of the optical fiber image transmission element are composed of one or more mono fibers that cannot emit light normally, in the end face image, the grayscale value of the pixels corresponding to the dark spots (and dust) is close to the grayscale value of the pixels corresponding to the clad glass of the normally luminous mono fibers and the grayscale value of the pixels corresponding to the gaps between the mono fibers. To avoid the influence of the clad glass of normally luminous mono fibers and the gaps between mono fibers on dark spot detection, after acquiring the plurality of end face images corresponding to the optical fiber image transmission element to be detected, the dark spot detection application program needs to perform secondary diffusion processing on each end face image according to a plurality of preset diffusion matrices. That is, a suitable preset diffusion matrix is selected from the plurality of preset diffusion matrices, and two diffusion processes are performed on each end face image based on the selected preset diffusion matrix, thereby generating a secondary diffusion image corresponding to each end face image.

Herein, for any end face image, in its corresponding secondary diffusion image, the grayscale value of the pixels corresponding to the clad glass of the normally luminous mono fibers and the grayscale value of the pixels corresponding to the gaps between the mono fibers are the same as the grayscale value of the pixels corresponding to the core glass of the normally luminous mono fibers. The grayscale value of the pixels corresponding to the clad glass of the normally luminous mono fibers, the grayscale value of the pixels corresponding to the gaps between the mono fibers, and the grayscale value of the pixels corresponding to the core glass of the normally luminous mono fibers are different from the grayscale value of the pixels corresponding to the dark spots (and dust) and the grayscale value of the pixels corresponding to the dust on the end face of the optical fiber image transmission element to be detected. For any end face image, its corresponding secondary diffusion image includes a plurality of closed regions, and each closed region corresponds to a dark spot.

103. Determining a number of dark spots comprised in each of the end face images and an area value corresponding to each of the dark spots according to a number of closed regions comprised in each of the secondary diffusion images and a number of pixel points comprised in each of the closed regions.

After generating the secondary diffusion image corresponding to each end face image, the dark spot detection application program may determine the number of dark spots included in each end face image and the area value corresponding to each dark spot according to the number of closed regions included in each secondary diffusion image and the number of pixels included in each closed region. Moreover, the number of dark spots on the end face of the optical fiber image transmission element to be detected and the area of each dark spot may be determined according to the number of dark spots included in each end face image and the area value corresponding to each dark spot. That is, when the plurality of end face images completely cover the end face of the optical fiber image transmission element to be detected, the sum of the number of dark spots included in the plurality of end face images is the number of dark spots on the end face of the optical fiber image transmission element to be detected, and the area value corresponding to each dark spot included in the plurality of end face images is the area of each dark spot on the end face of the optical fiber image transmission element to be detected.

Specifically, in this step, for any end face image, the specific process of determining the number of dark spots included in the end face image and the area value corresponding to each dark spot according to the number of closed regions included in the secondary diffusion image corresponding to the end face image and the number of pixels included in each closed region is as follows:

First, according to the diameter of the mono fiber corresponding to the optical fiber image transmission element to be detected and the pixel pitch corresponding to the end face image, calculate the number of pixels occupied by the diameter of the mono fiber. That is, divide the diameter of the mono fiber corresponding to the optical fiber image transmission element to be detected by the pixel pitch (side length of the pixel) corresponding to the end face image, and determine the calculation result as the number of pixels occupied by the diameter of the mono fiber. Herein, the number of pixels occupied by the diameter of the mono fiber refers to the number of pixels occupied by the diameter of the mono fiber in the end face image. Secondly, calculate the number of pixels occupied by the mono fiber according to the number of pixels occupied by the diameter of the mono fiber, wherein the number of pixels occupied by the mono fiber is the number of pixels occupied by the end face of the mono fiber in the end face image. Thirdly, for any closed region included in the secondary diffusion image, when the number of pixels included in the closed region is less than the number of pixels occupied by the mono fiber, it is determined that the closed region corresponds to dust; when the number of pixels included in the closed region is greater than or equal to the number of pixels occupied by the mono fiber, it is determined that the closed region corresponds to a dark spot. Finally, count the number of closed regions corresponding to dust, the number of closed regions corresponding to dark spots, and the number of pixels included in each closed region corresponding to dark spots among the plurality of closed regions included in the secondary diffusion image. If the number of closed regions corresponding to dust is greater than a preset threshold, output and display a prompt message to remind the inspectors that there is too much dust on the end face of the optical fiber image transmission element to be detected, and that it is necessary to wipe the optical fiber image transmission element to be detected and then re-capture the plurality of end face images corresponding to the optical fiber image transmission element to be detected. If the number of closed regions corresponding to dust is less than or equal to the preset threshold, calculate the area value corresponding to each closed region according to the number of pixels included in each closed region corresponding to dark spots and the pixel area value corresponding to the end face image (which is calculated according to the side length of the pixel). Then, determine the number of closed regions corresponding to dark spots as the number of dark spots included in the end face image, and determine the area value corresponding to each closed region corresponding to dark spots as the area value corresponding to each dark spot included in the end face image.

The embodiment of the present application provides a method for detecting dark spots on the end face of an optical fiber image transmission element. In this embodiment, after an inspector captures a plurality of end face images corresponding to the optical fiber image transmission element to be detected through a photographing device and store these a plurality of end face images in the local storage space of the target terminal device, the dark spot detection application program may obtain the plurality of end face images corresponding to the optical fiber image transmission element to be detected from the local storage space of the target terminal device. Then, it performs secondary diffusion processing on each end face image according to a plurality of preset diffusion matrices to generate a secondary diffusion image corresponding to each end face image. For any end face image, its corresponding secondary diffusion image includes a plurality of closed regions, and each closed region corresponds to a dark spot. Furthermore, the number of dark spots in each end face image and the area value corresponding to each dark spot are determined based on the number of closed regions in each secondary diffusion image and the number of pixels in each closed region. In the embodiment of the present application, since the inspectors only need to capture a plurality of end face images of the optical fiber image transmission element to be detected through the photographing device, the dark spot detection application program may determine the number of dark spots in each end face image and the area value corresponding to each dark spot, as well as the number of dark spots on the end face of the optical fiber image transmission element to be detected and the area of each dark spot. The entire process does not require the intervention of inspectors, thus being independent of the work experience and working state of inspectors, and may improve the detection accuracy of dark spot detection for optical fiber image transmission elements.

For a more detailed explanation, the embodiment of the present application provides another method for detecting dark spots on the end face of an optical fiber image transmission element, as specifically shown in FIG. 2, which includes at least steps 201-204.

201. Acquiring a plurality of end face images corresponding to the optical fiber image transmission element to be detected.

Herein, regarding step 201: acquiring a plurality of end face images corresponding to the optical fiber image transmission element to be detected, reference may be made to the description of the corresponding part in FIG. 1, and details will not be repeated herein in the embodiment of the present application.

202. Performing secondary diffusion processing on each end face image according to a plurality of preset diffusion matrices to generate a secondary diffusion image corresponding to each end face image.

To avoid the impact of the clad glass of normally luminous mono fibers and the gaps between mono fibers on dark spot detection, after acquiring a plurality of end face images corresponding to the optical fiber image transmission element to be detected, the dark spot detection application program needs to perform secondary diffusion processing on each end face image according to a plurality of preset diffusion matrices. That is, a suitable preset diffusion matrix is selected from the plurality of preset diffusion matrices, and two diffusion processes are performed on each end face image based on the selected preset diffusion matrix, thereby generating a secondary diffusion image corresponding to each end face image. The following is a detailed description of how the dark spot detection application program performs secondary diffusion processing on each end face image according to a plurality of preset diffusion matrices to generate a secondary diffusion image corresponding to each end face image:
(1) Calculate the number of pixels occupied by the diameter of the mono fiber according to the diameter of the mono fiber corresponding to the optical fiber image transmission element to be detected and the pixel pitch corresponding to the end face image. That is, divide the diameter of the mono fiber corresponding to the optical fiber image transmission element to be detected by the pixel pitch (the side length of the pixel) corresponding to the end face image, and determine the calculation result as the number of pixels occupied by the diameter of the mono fiber. Herein, the number of pixels occupied by the diameter of the mono fiber refers to the number of pixels occupied by the diameter of the mono fiber in the end face image.
(2) Generate a target noise reduction matrix according to the number of pixels occupied by the diameter of the mono fiber; select a first target diffusion matrix from the plurality of preset diffusion matrices according to the number of pixels occupied by the diameter of the mono fiber; and select a second target diffusion matrix from the plurality of preset diffusion matrices.

Herein, when the number of pixels occupied by the diameter of the mono fiber is an odd number, the generated target noise reduction matrix is specifically:
nk nk nk . . . nk nk nk
nk:nk
nk n3 n3 n3 nk
: . . . n3 n1 n3 . . . :
nk n3 n3 n3 nk
nk:nk
nk nk nk . . . nk nk nk
Herein, the target noise reduction matrix is a k×k matrix. The target noise reduction matrix takes n1 as the center, a circle of elements surrounding n1 are all n3, a circle of elements surrounding the plurality of n3 are n5 . . . and the outermost circle of elements are nk, wherein k is the number of pixels occupied by the diameter of the mono fiber; wherein, the sum of the plurality of elements included in the target noise reduction matrix is equal to 1.

Herein, n1=2/(k+1), ni=1/[2(k+1)(i−1)], wherein i=3, 5, 7 . . . k.

Herein, when the number of pixels occupied by the diameter of the mono fiber is an even number, the generated target noise reduction matrix is specifically:
nk nk nk . . . nk nk nk
nk:nk
nk n4 n4 n4 n4 nk
: . . . n4 n2 n2 n4 . . . :
: n4 n2 n2 n4 :
nk n4 n4 n4 n4 nk
nk:nk
nk nk nk . . . nk nk nk

Herein, the target noise reduction matrix is a k×k matrix. The target noise reduction matrix takes a 2×2 matrix as the center, each element in the 2×2 matrix is n2, a circle of elements surrounding the 2×2 matrix are all n4, a circle of elements surrounding the plurality of n4 are n6 . . . and the outermost circle of elements are nk, wherein k is the number of pixels occupied by the diameter of the mono fiber; wherein, the sum of the plurality of elements included in the target noise reduction matrix is equal to 1.

Herein, ni=1/[2k(i−1)], wherein i=2, 4, 6 . . . k.

Herein, the specific process of selecting the first target diffusion matrix from the plurality of preset diffusion matrices and selecting the second target diffusion matrix from the plurality of preset diffusion matrices according to the number of pixels occupied by the diameter of the mono fiber is as follows:
First, divide the number of pixels occupied by the diameter of the mono fiber by 6 to obtain a value A. Then, determine the preset diffusion matrix with the number of columns closest to the value A among the plurality of preset diffusion matrices as the first target diffusion matrix. For example, if the number of pixels occupied by the diameter of the mono fiber is 29, the value A is equal to 4.83. Therefore, the first preset diffusion matrix is determined as the first target diffusion matrix. Second, the second preset diffusion matrix may be, but is not limited to being, determined as the second target diffusion matrix.

(3) Perform a convolution processing on each end face image using the target noise reduction matrix to obtain a noise-reduced image corresponding to each end face image.

Herein, the type of convolution processing performed may specifically be a same convolution processing. That is, for any end face image, a same convolution processing is performed on the end face image using the target noise reduction matrix to obtain a noise-reduced image corresponding to the end face image.

Herein, performing a convolution processing on the end face image using the target noise reduction matrix may suppress noise points in the end face image.

(4) Perform diffusion processing on each noise-reduced image according to the first target diffusion matrix to obtain a primary diffusion image corresponding to each end face image.

For any end face image:
First of all, perform a convolution processing on the noise-reduced image corresponding to the end face image using a preset two-dimensional gradient operator to obtain a gradient matrix corresponding to the noise-reduced image. Herein, the type of convolution processing performed may specifically be a same convolution processing. The preset two-dimensional gradient operator may be, but is not limited to, a Laplacian operator, a Sobel operator, etc. The plurality of pixels in the noise-reduced image correspond one-to-one to the plurality of elements in the gradient matrix, and the elements in the gradient matrix indicate the gradient values of their corresponding pixels.
Secondly, divide the maximum value among the gradient values corresponding to each element in the gradient matrix by 2 to obtain a target gradient value;
Thirdly, determine the elements in the gradient matrix with gradient values greater than the target gradient value as target elements, and determine the pixels corresponding to each target element as target pixels. Herein, the target pixels are the pixels at the edge of the core glass in the normally luminous mono fiber.

Then, determine the position coordinates of a plurality of pixels to be diffused corresponding to each target pixel according to the positional relationship between the central element and each element to be diffused included in the first target diffusion matrix and the position coordinates corresponding to each target pixel. Herein, the position coordinates corresponding to the target pixel are the coordinates of the target pixel in the noise-reduced image, and the position coordinates corresponding to the pixel to be diffused are the coordinates of the pixel to be diffused in the noise-reduced image. For example, the first target diffusion matrix is specifically:
C B B C
B A B B

### C B B C

The positional relationship between the central element and each element to be diffused is as follows: the first element to be diffused is directly above the central element, the second element to be diffused is diagonally above and to the right of the central element, the third element to be diffused is to the left of the central element. When the position coordinates corresponding to a certain target pixel are (200, 200), that is, the target pixel is the pixel at the 200th row and 200th column in the noise-reduced image, the position coordinates of the first pixel to be diffused corresponding to the target pixel are (199, 200), the position coordinates of the second pixel to be diffused are (199, 201), the position coordinates of the third pixel to be diffused are (200, 199).

Finally, set the grayscale value of each pixel to be diffused in the noise-reduced image to the grayscale value of its corresponding target pixel according to the position coordinates of the plurality of pixels to be diffused corresponding to each target pixel, so as to obtain a primary diffusion image corresponding to the end face image. That is, for any target pixel, find the plurality of pixels to be diffused corresponding to the target pixel in the noise-reduced image according to the position coordinates of each pixel to be diffused corresponding to the target pixel, and then set the grayscale values of the plurality of pixels to be diffused corresponding to the target pixel to the grayscale value of the target pixel.

(5) Perform inverse binarization processing on each primary diffusion image according to a plurality of preset grayscale thresholds to generate a target binary image corresponding to each end face image.

For any end face image:
First of all, perform inverse binarization processing on the primary diffusion image corresponding to the end face image according to a plurality of preset grayscale thresholds to generate a binary image corresponding to each preset grayscale threshold. For example, the plurality of preset grayscale thresholds are 130, 120, 110, 100, 90, 80, etc. Set the grayscale values of a plurality of pixels in the primary diffusion image with grayscale values greater than 130 to 0, and set the grayscale values of a plurality of pixels in the primary diffusion image with grayscale values less than or equal to 130 to 1 to generate a binary image corresponding to the preset grayscale threshold of 130. Set the grayscale values of a plurality of pixels in the primary diffusion image with grayscale values greater than 120 to 0, and set the grayscale values of a plurality of pixels in the primary diffusion image with grayscale values less than or equal to 120 to 1 to generate a binary image corresponding to the preset grayscale threshold of 120. . . ;
Secondly, determine the number of closed regions included in the binary image corresponding to each preset grayscale threshold;
Thirdly, calculate the difference in the number of closed regions between the binary images corresponding to two adjacent preset grayscale thresholds. Specifically, calculate the difference between the number of closed regions in the binary image corresponding to the first preset grayscale threshold and that in the binary image corresponding to the second preset grayscale threshold to obtain the first difference in the number of closed regions; calculate the difference between the number of closed regions in the binary image corresponding to the second preset grayscale threshold and that in the binary image corresponding to the third preset grayscale threshold to obtain the second difference in the number of closed regions; calculate the difference between the number of closed regions in the binary image corresponding to the third preset grayscale threshold and that in the binary image corresponding to the fourth preset grayscale threshold to obtain the third difference in the number of closed regions . . . ;
Finally, determine the preset grayscale threshold with the smaller value among the two adjacent preset grayscale thresholds corresponding to the maximum difference in the number of closed regions as the target grayscale threshold, and determine the binary image corresponding to the target grayscale threshold as the target binary image corresponding to the end face image. For example, if the difference between the number of closed regions in the binary image corresponding to the preset grayscale threshold of 110 and the number of closed regions in the binary image corresponding to the preset grayscale threshold of 100 is the maximum difference among the plurality of differences in the number of closed regions, then determine the preset grayscale threshold of 100 as the target grayscale threshold, and determine the binary image corresponding to the preset grayscale threshold of 100 as the target binary image corresponding to the end face image.

(6) Perform diffusion processing on each target binary image using the second target diffusion matrix to obtain a secondary diffusion image corresponding to each end face image.

For any end face image:
First of all, perform a convolution processing on the target binary image corresponding to the end face image using a preset two-dimensional gradient operator to obtain a gradient matrix corresponding to the target binary image. Herein, the type of convolution processing performed may specifically be a same convolution processing. The preset two-dimensional gradient operator may be, but is not limited to, a Laplacian operator, a Sobel operator, etc. The plurality of pixels in the target binary image correspond one-to-one to the plurality of elements in the gradient matrix, and the elements in the gradient matrix indicate the gradient values of their corresponding pixels;
Secondly, determine the elements with non-zero gradient values in the gradient matrix as target elements, and among the pixels corresponding to the plurality of target elements, determine the pixels with a grayscale value of zero as target pixels. Herein, the target pixels are the pixels at the edges of the normally luminous optical mono fibers
Thirdly, determine the position coordinates of a plurality of pixels to be diffused corresponding to each target pixel according to the positional relationship between the central element and each element to be diffused included in the second target diffusion matrix and the position coordinates corresponding to each target pixel. Herein, the position coordinates corresponding to the target pixel are the coordinates of the target pixel in the target binary image, and the position coordinates corresponding to the pixel to be diffused are the coordinates of the pixel to be diffused in the target binary image. For the specific process, reference may be made to the above process of determining the position coordinates of a plurality of pixels to be diffused corresponding to each target pixel according to the positional relationship between the central element and each element to be diffused included in the first target diffusion matrix and the position coordinates corresponding to each target pixel, which is not repeated in this embodiment of the present application;
Finally, set the grayscale value of each pixel to be diffused in the target binary image to zero according to the position coordinates of the plurality of pixels to be diffused corresponding to each target pixel, so as to obtain a secondary diffusion image corresponding to the end face image. That is, for any target pixel, find the plurality of pixels to be diffused corresponding to the target pixel in the target binary image according to the position coordinates of each pixel to be diffused corresponding to the target pixel, and then set the grayscale values of the plurality of pixels to be diffused corresponding to the target pixel to zero.

It should be noted that during the first diffusion processing, the grayscale values of the pixels corresponding to the clad glass of the normally luminous optical mono fibers may be set to be consistent with the grayscale values of the pixels corresponding to the core glass of the normally luminous optical mono fibers; during the second diffusion processing, the grayscale values of the pixels corresponding to the gaps between the optical mono fibers may be set to be consistent with the grayscale values of the pixels corresponding to the core glass of the normally luminous optical mono fibers. Thus, the impact of the clad glass of the normally luminous optical mono fibers and the gaps between the optical mono fibers on dark spot detection may be effectively avoided.

203. Performing edge processing on each secondary diffusion image based on a preset two-dimensional gradient operator to obtain an edge image corresponding to each end face image.

After generating the secondary diffusion image corresponding to each end face image, the dark spot detection application may perform edge processing on each secondary diffusion image based on a preset two-dimensional gradient operator to obtain an edge image corresponding to each end face image. The specific process is as follows: First, perform a convolution processing on each secondary diffusion image using a preset two-dimensional gradient operator to obtain a gradient matrix corresponding to each secondary diffusion image. Herein, the type of convolution processing performed may specifically be a same convolution processing, and the preset two-dimensional gradient operator may be, but is not limited to, a Laplacian operator, a Sobel operator, etc. For any secondary diffusion image, the plurality of pixels in the secondary diffusion image correspond one-to-one to the plurality of elements in the gradient matrix corresponding to the secondary diffusion image, and the elements in the gradient matrix corresponding to the secondary diffusion image indicate the gradient values of their corresponding pixels; Second, perform edge processing on each secondary diffusion image according to the gradient matrix corresponding to each secondary diffusion image to obtain an edge image corresponding to each end face image. That is, for any secondary diffusion image, determine the elements with non-zero gradient values in the gradient matrix corresponding to the secondary diffusion image as target elements, determine the pixel corresponding to each target element as a target pixel, and in the secondary diffusion image, set the grayscale value of each target pixel to one and set the grayscale values of other pixels except the target pixels to zero, thereby obtaining an edge image. Herein, the target pixels are the pixels at the edges of dark spots, that is, the grayscale value of the pixel at the edge of each dark spot in the edge image is one, and the grayscale values of other pixels are zero. Therefore, inspectors may quickly know the position of each dark spot according to the edge image.

204. Determining the number of dark spots included in each end face image and the area value corresponding to each dark spot according to the number of closed regions included in each edge image and the number of pixels included in each closed region.

Herein, regarding 204, determine the number of dark spots included in each end face image and the area value corresponding to each dark spot according to the number of closed regions included in each edge image and the number of pixels included in each closed region, reference may be made to the relevant description of the above step 103, which will not be repeated herein in this embodiment of the present application.

Further, in this embodiment of the present application, after determining the number of dark spots included in each end face image corresponding to the optical fiber image transmission element to be detected and the area value corresponding to each dark spot, it is also possible to determine whether the optical fiber image transmission element to be detected is a qualified element for dark spot detection according to the number of dark spots included in each end face image and the area value corresponding to each dark spot. The specific process is as follows: First, determine the total area value corresponding to the plurality of first dark spots included in each end face image, and determine the number of second dark spots, the number of third dark spots, and the number of fourth dark spots included in each end face image. Herein, the first dark spots are the dark spots in the end face image with an area value less than or equal to a first preset area threshold, the second dark spots are the dark spots in the end face image with an area value greater than the first preset area threshold and less than or equal to a second preset area threshold, the third dark spots are the dark spots in the end face image with an area value greater than the second preset area threshold and less than or equal to a third preset area threshold, and the fourth dark spots are the dark spots in the end face image with an area value greater than the third preset area threshold. When the total area value corresponding to the plurality of first dark spots included in any end face image is greater than a fourth preset area threshold, determine that the optical fiber image transmission element to be detected is a non-qualified element for dark spot detection. When the number of second dark spots included in any end face image is greater than a first quantity threshold, determine that the optical fiber image transmission element to be detected is a non-qualified element for dark spot detection. When the number of third dark spots included in any end face image is greater than a second quantity threshold, determine that the optical fiber image transmission element to be detected is a non-qualified element for dark spot detection. When the number of fourth dark spots included in any end face image is greater than a third quantity threshold, determine that the optical fiber image transmission element to be detected is a non-qualified element for dark spot detection.

Herein, the first preset area threshold may be, but is not limited to, the total end face area corresponding to three optical mono fibers, the total end face area corresponding to four optical mono fibers, the total end face area corresponding to five optical mono fibers, etc. The second preset area threshold may be, but is not limited to, the total end face area corresponding to eight optical mono fibers, the total end face area corresponding to ten optical mono fibers, the total end face area corresponding to twelve optical mono fibers, etc. The third preset area threshold may be, but is not limited to, the total end face area corresponding to thirteen optical mono fibers, the total end face area corresponding to fifteen optical mono fibers, the total end face area corresponding to seventeen optical mono fibers, etc. The third preset area threshold is greater than the second preset area threshold, and the second preset area threshold is greater than the first preset area threshold. The fourth preset area threshold may be, but is not limited to, 2% of the end face image area, 3% of the end face image area, 4% of the end face image area, etc. Herein, the first quantity threshold may be, but is not limited to three, four, five, etc., the second quantity threshold may be, but is not limited to one, two, etc., and the third quantity threshold may be, but is not limited to one, etc.

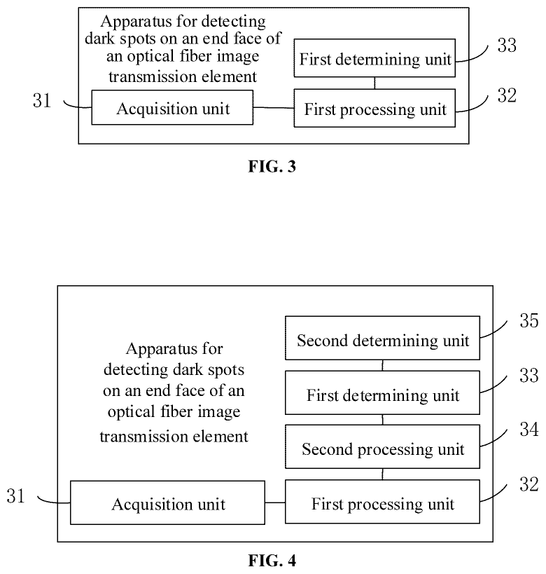

Further, as an implementation of the methods shown in FIG. 1 and FIG. 2 above, another embodiment of the present application also provides an apparatus for detecting dark spots on the end face of an optical fiber image transmission element. This apparatus embodiment corresponds to the aforementioned method embodiment. For ease of reading, this apparatus embodiment will not reiterate the details in the aforementioned method embodiment one by one, but it should be clear that the apparatus in this embodiment may correspondingly implement all the contents in the aforementioned method embodiment. The apparatus is applied to improve the detection accuracy of dark spot detection for optical fiber image transmission elements, and is specifically shown in FIG. 3. The apparatus includes:
An acquisition unit 31 configured to, acquire a plurality of end face images corresponding to a optical fiber image transmission element to be detected, wherein the plurality of end face images are images obtained by photographing different regions of the end face of the optical fiber image transmission element to be detected with a photographing device;
A first processing unit 32, configured to perform secondary diffusion processing on each of the end face images acquired by the acquisition unit 31 according to a plurality of preset diffusion matrices, so as to generate a secondary diffusion image corresponding to each end face image, wherein the secondary diffusion image includes a plurality of closed regions;
A first determining unit 33, configured to determine the number of dark spots included in each end face image and the area value corresponding to each dark spot according to the number of closed regions included in each secondary diffusion image generated by the first processing unit 32 and the number of pixels included in each closed region.

Further, as shown in FIG. 4, the first processing unit 32 is specifically configured to, calculate the number of pixels occupied by the diameter of the optical mono fiber according to the diameter of the optical mono fiber corresponding to the optical fiber image transmission element to be detected and the pitch of the pixel points corresponding to the end face image.

Generate a target noise reduction matrix according to the number of pixels occupied by the diameter of the optical mono fiber, select a first target diffusion matrix from the plurality of preset diffusion matrices according to the number of pixels occupied by the diameter of the optical mono fiber, and select a second target diffusion matrix from the plurality of preset diffusion matrices.

Perform convolution processing on each end face image using the target noise reduction matrix to obtain a noise-reduced image corresponding to each end face image;

Perform diffusion processing on each noise-reduced image according to the first target diffusion matrix to obtain a primary diffusion image corresponding to each end face image.

Perform reverse binarization processing on each primary diffusion image according to a plurality of preset grayscale thresholds to generate a target binary image corresponding to each end face image;

Perform diffusion processing on each target binary image according to the second target diffusion matrix to obtain a secondary diffusion image corresponding to each end face image.

Further, as shown in FIG. 4, the first target diffusion matrix includes a central element and a plurality of elements to be diffused; the first processing unit 32 is specifically configured to, perform convolution processing on the noise-reduced image using a preset two-dimensional gradient operator to obtain a gradient matrix corresponding to the noise-reduced image, wherein a plurality of pixels in the noise-reduced image correspond one-to-one to a plurality of elements in the gradient matrix, and the elements in the gradient matrix indicate the gradient values of their corresponding pixels;

Divide the maximum value among the gradient values corresponding to each element in the gradient matrix by two to obtain a target gradient value;

Determine the elements in the gradient matrix whose gradient values are greater than the target gradient value as target elements, and determine the pixel corresponding to each target element as a target pixel;

Determine the position coordinates of a plurality of pixels to be diffused corresponding to each target pixel according to the positional relationship between the central element and each element to be diffused and the position coordinates corresponding to each target pixel;

Set the grayscale value of each pixel to be diffused in the noise-reduced image to the grayscale value of its corresponding target pixel according to the position coordinates of the plurality of pixels to be diffused corresponding to each target pixel, so as to obtain the primary diffusion image corresponding to the end face image.

Further, as shown in FIG. 4, the first processing unit 32 is specifically configured to, perform reverse binarization processing on the primary diffusion image according to a plurality of the preset grayscale thresholds, so as to generate a binary image corresponding to each of the preset grayscale thresholds;

Determine the number of closed regions corresponding to each binary image;

Calculate the difference in the number of closed regions between the binary images corresponding to two adjacent preset grayscale thresholds;

Determine the preset grayscale threshold with the smaller value among the two adjacent preset grayscale thresholds corresponding to the maximum difference in the number of closed regions among the plurality of differences in the number of closed regions as the target grayscale threshold;

Determine the binary image corresponding to the target grayscale threshold as the target binary image corresponding to the end face image.

Further, as shown in FIG. 4, the second target diffusion matrix includes a central element and a plurality of elements to be diffused; the first processing unit 32 is specifically configured to, perform convolution processing on the target binary image using a preset two-dimensional gradient operator to obtain a gradient matrix corresponding to the target binary image, wherein a plurality of pixels in the target binary image correspond one-to-one to a plurality of elements in the gradient matrix, and the elements in the gradient matrix indicate the gradient values of their corresponding pixels;

Determine elements in the gradient matrix with non-zero gradient values as target elements, and among the pixels corresponding to the plurality of target elements, determine pixels with a grayscale value of zero as target pixels;

Determine the position coordinates of a plurality of pixels to be diffused corresponding to each target pixel according to the positional relationship between the central element and each element to be diffused, and the position coordinates corresponding to each target pixel;

Set the grayscale value of each pixel to be diffused in the target binary image to zero according to the position coordinates of the plurality of pixels to be diffused corresponding to each target pixel, so as to obtain the secondary diffusion image corresponding to the end face image.

Further, as shown in FIG. 4, the apparatus further includes:
The second processing unit 34 is configured to, after the first processing unit 32 performs secondary diffusion processing on each of the end face images according to the plurality of preset diffusion matrices to generate a secondary diffusion image corresponding to each of the end face images, perform convolution processing on each of the secondary diffusion images using a preset two-dimensional gradient operator to obtain a gradient matrix corresponding to each of the secondary diffusion images; and perform marginalization processing on each of the secondary diffusion images according to the gradient matrix corresponding to each of the secondary diffusion images to obtain an edge image corresponding to each of the end face images;
The first determining unit 33 is specifically configured to, determine the number of dark spots included in each end face image and the area value corresponding to each dark spot according to the number of closed regions included in each edge image and the number of pixels included in each closed region.

Further, as shown in FIG. 4, the apparatus further includes:
The second determining unit 35 is configured to, determine a total area value corresponding to a plurality of first dark spots included in each end face image, and determine the number of second dark spots, the number of third dark spots, and the number of fourth dark spots included in each end face image, wherein the first dark spots are dark spots in the end face image with an area value less than or equal to a first preset area threshold, the second dark spots are dark spots in the end face image with an area value greater than the first preset area threshold and less than or equal to a second preset area threshold, the third dark spots are dark spots in the end face image with an area value greater than the second preset area threshold and less than or equal to a third preset area threshold, and the fourth dark spots are dark spots in the end face image with an area value greater than the third preset area threshold;
The second determining unit 35 is configured to, determine that the optical fiber image transmission element to be detected is an element that fails the dark spot detection when the total area value corresponding to the plurality of first dark spots included in any one of the end face images is greater than a fourth preset area threshold;
The second determining unit 35 is configured to, determine that the optical fiber image transmission element to be detected is an element that fails the dark spot detection when the number of the second dark spots included in any one of the end face images is greater than a first quantity threshold;

The second determining unit 35 is configured to, determine that the optical fiber image transmission element to be detected is an element that fails the dark spot detection when the number of the third dark spots included in any one of the end face images is greater than a second quantity threshold;

The second determining unit 35 is configured to, determine that the optical fiber image transmission element to be detected is an element that fails the dark spot detection when the number of the fourth dark spots included in any one of the end face images is greater than a third quantity threshold.

An embodiment of the present application provides a method and apparatus for detecting dark spots on an end face of an optical fiber image transmission element. After an inspector captures, using an imaging device, a plurality of end face images corresponding to an optical fiber image transmission element to be detected and stores the plurality of end face images corresponding to the optical fiber image transmission element to be detected in a local storage space of a target terminal device, a dark spot detection application in the target terminal device may obtain the plurality of end face images corresponding to the optical fiber image transmission element to be detected from the local storage space of the target terminal device, perform secondary diffusion processing on each end face image according to a plurality of preset diffusion matrices, to generate a secondary diffusion image corresponding to each end face image, wherein, for any end face image, the corresponding secondary diffusion image includes a plurality of closed regions, and for any closed region, the closed region corresponds to a dark spot; and determine the number of dark spots included in each end face image and an area value corresponding to each dark spot according to the number of closed regions included in each secondary diffusion image and the number of pixels included in each closed region. In the embodiment of the present application, the dark spot detection application may determine the number of dark spots included in each end face image and the area value corresponding to each dark spot, and determine the number of dark spots included in the end face of the optical fiber image transmission element to be detected and the area pitch of each dark spot, simply by the inspector capturing the plurality of end face images corresponding to the optical fiber image transmission element to be detected using the imaging device. The entire process does not require the intervention of the inspector, and thus does not depend on the work experience and working state of the detection personnel, thereby improving the detection accuracy of dark spot detection on the optical fiber image transmission element.

An embodiment of the present application provides a storage medium, wherein the storage medium includes a stored program, and when the program runs, the device where the storage medium is located is controlled to execute the above-mentioned method for detecting dark spots on the end face of an optical fiber image transmission element.

The storage medium may include non-permanent memory in computer-readable media, in the forms of random access memory (RAM) and/or non-volatile memory, such as read-only memory (ROM) or flash memory (flash RAM), and the memory includes at least one storage chip.

An embodiment of the present application further provides an apparatus for detecting dark spots on an end face of an optical fiber image transmission element, where the apparatus includes a storage medium; and one or more processors, where the storage medium is coupled to the processors, and the processors are configured to execute program instructions stored in the storage medium; and when the program instructions run, the above-mentioned method for detecting dark spots on the end face of an optical fiber image transmission element is executed.

An embodiment of the present application provides a device, which includes a processor, a memory, and a program stored in the memory and executable on the processor. When the processor executes the program, the following steps are implemented:
Acquiring a plurality of end face images corresponding to an optical fiber image transmission element to be detected, wherein the plurality of end face images are images obtained by photographing different regions of the end face of the optical fiber image transmission element to be detected with a photographing device;
Performing secondary diffusion processing on each of the end face images according to a plurality of preset diffusion matrices to generate a secondary diffusion image corresponding to each of the end face images, wherein the secondary diffusion image includes a plurality of closed regions; and
Determining a number of dark spots included in each of the end face images and an area value corresponding to each of the dark spots according to a number of closed regions included in each of the secondary diffusion images and a number of pixel points included in each of the closed regions.

Further, performing secondary diffusion processing on each of the end face images according to a plurality of preset diffusion matrices to generate a secondary diffusion image corresponding to each of the end face images includes:
Calculating the number of pixel points occupied by a mono fiber diameter corresponding to the optical fiber image transmission element to be detected according to the mono fiber diameter and a pixel point pitch corresponding to the end face image;
Generating a target noise reduction matrix according to the number of pixel points occupied by the mono fiber diameter, selecting a first target diffusion matrix from the plurality of preset diffusion matrices according to the number of pixel points occupied by the mono fiber diameter, and selecting a second target diffusion matrix from the plurality of preset diffusion matrices;
Performing convolution processing on each of the end face images with the target noise reduction matrix to obtain a noise-reduced image corresponding to each of the end face images;
Performing diffusion processing on each of the noise-reduced images according to the first target diffusion matrix to obtain a primary diffusion image corresponding to each of the end face images;
Performing inverse binarization processing on each of the primary diffusion images according to a plurality of preset gray thresholds to generate a target binary image corresponding to each of the end face images; and
Performing diffusion processing on each of the target binary images according to the second target diffusion matrix to obtain a secondary diffusion image corresponding to each of the end face images.

Further, the first target diffusion matrix includes a central element and a plurality of elements to be diffused; and performing diffusion processing on each of the noise-reduced images according to the first target diffusion matrix to obtain a primary diffusion image corresponding to each of the end face images, including:
Performing convolution processing on the noise-reduced image with a preset two-dimensional gradient operator to obtain a gradient matrix corresponding to the noise-reduced image, wherein a plurality of pixel points in the noise-reduced image correspond one-to-one to a plurality of elements in the gradient matrix, and elements in the gradient matrix indicate gradient values of their corresponding pixel points;
Dividing a maximum value among gradient values corresponding to respective elements in the gradient matrix by two to obtain a target gradient value;
Determining elements in the gradient matrix having gradient values greater than the target gradient value as target elements, and determining pixel points corresponding to each of the target elements as target pixel points;
Determining position coordinates of a plurality of pixel points to be diffused corresponding to each of the target pixel points according to a positional relationship between the central element and each of the elements to be diffused and position coordinates corresponding to each of the target pixel points; and
Setting a gray value of each of the pixel points to be diffused in the noise-reduced image to a gray value of its corresponding target pixel point according to the position coordinates of the plurality of pixel points to be diffused corresponding to each of the target pixel points, to obtain the primary diffusion image corresponding to the end face image.

Further, performing inverse binarization processing on each of the primary diffusion images according to a plurality of preset gray thresholds to generate a target binary image corresponding to each of the end face images includes:
Performing inverse binarization processing on the primary diffusion image according to the plurality of preset gray thresholds to generate a binary image corresponding to each of the preset gray thresholds;
Determining the number of closed regions corresponding to each of the binary images;
Calculating a difference in the number of closed regions between binary images corresponding to two adjacent preset gray thresholds;
Determining, as a target gray threshold, a preset gray threshold having a smaller value among two adjacent preset gray thresholds corresponding to a maximum difference in the number of closed regions among a plurality of differences in the number of closed regions; and
Determining the binary image corresponding to the target gray threshold as the target binary image corresponding to the end face image.

Further, the second target diffusion matrix includes a central element and a plurality of elements to be diffused; and the performing diffusion processing on each of the target binary images according to the second target diffusion matrix to obtain a secondary diffusion image corresponding to each of the end face images includes:
Performing convolution processing on the target binary image with a preset two-dimensional gradient operator to obtain a gradient matrix corresponding to the target binary image, wherein a plurality of pixel points in the target binary image correspond one-to-one to a plurality of elements in the gradient matrix, and elements in the gradient matrix indicate gradient values of their corresponding pixel points;
Determining elements in the gradient matrix having non-zero gradient values as target elements, and determining, as target pixel points, pixel points having a gray value of zero among pixel points corresponding to the plurality of target elements;
Determining position coordinates of a plurality of pixel points to be diffused corresponding to each of the target pixel points according to a positional relationship between the central element and each of the elements to be diffused and position coordinates corresponding to each of the target pixel points; and
Setting a gray value of each of the pixel points to be diffused in the target binary image to zero according to the position coordinates of the plurality of pixel points to be diffused corresponding to each of the target pixel points, to obtain the secondary diffusion image corresponding to the end face image.

Further, after performing secondary diffusion processing on each of the end face images according to a plurality of preset diffusion matrices to generate a secondary diffusion image corresponding to each of the end face images, the method further includes:
Performing convolution processing on each of the secondary diffusion images with a preset two-dimensional gradient operator to obtain a gradient matrix corresponding to each of the secondary diffusion images; and
Performing edge processing on each of the secondary diffusion images according to the gradient matrix corresponding to each of the secondary diffusion images to obtain an edge image corresponding to each of the end face images; and
Determining the number of dark spots included in each of the end face images and an area value corresponding to each of the dark spots according to the number of closed regions included in each of the secondary diffusion images and the number of pixel points included in each of the closed regions includes:
Determining the number of dark spots included in each of the end face images and an area value corresponding to each of the dark spots according to the number of closed regions included in each of the edge images and the number of pixel points included in each of the closed regions.

Further, the method further includes:
Determining a total area value corresponding to a plurality of first dark spots included in each of the end face images, and determining a number of second dark spots, a number of third dark spots, and a number of fourth dark spots included in each of the end face images, wherein the first dark spots are dark spots having an area value less than or equal to a first preset area threshold in the end face image, the second dark spots are dark spots having an area value greater than the first preset area threshold and less than or equal to a second preset area threshold in the end face image, the third dark spots are dark spots having an area value greater than the second preset area threshold and less than or equal to a third preset area threshold in the end face image, and the fourth dark spots are dark spots having an area value greater than the third preset area threshold in the end face image;
Determining the optical fiber image transmission element to be detected as a dark spot detection failed element when the total area value corresponding to the plurality of first dark spots included in any one of the end face images is greater than a fourth preset area threshold;
Determining the optical fiber image transmission element to be detected as a dark spot detection failed element when the number of second dark spots included in any one of the end face images is greater than a first quantity threshold;
Determining the optical fiber image transmission element to be detected as a dark spot detection failed element when the number of third dark spots included in any one of the end face images is greater than a second quantity threshold; and
Determining the optical fiber image transmission element to be detected as a dark spot detection failed element when the number of fourth dark spots included in any one of the end face images is greater than a third quantity threshold.

The present application also provides a computer program product, which, when executed on a data processing device, is adapted to execute program code initialized with the following method steps: acquiring a plurality of end face images corresponding to an optical fiber image transmission element to be detected, wherein the plurality of end face images are images obtained by photographing different regions of the end face of the optical fiber image transmission element to be detected using a photographing device; performing secondary diffusion processing on each of the end face images according to a plurality of preset diffusion matrices to generate a secondary diffusion image corresponding to each of the end face images, wherein the secondary diffusion image includes a plurality of closed regions; determining the number of dark spots included in each of the end face images and the area value corresponding to each dark spot according to the number of closed regions included in each of the secondary diffusion images and the number of pixels included in each closed region.

Those skilled in the art will appreciate that embodiments of the present application may be provided as a method, system, or computer program product. Accordingly, the present application may take the form of an entirely hardware embodiment, an entirely software embodiment, or an embodiment combining software and hardware aspects. Furthermore, the present application may take the form of a computer program product implemented on one or more computer-usable storage media (including, but not limited to, disk storage, CD-ROM, optical storage, etc.) having computer-usable program code embodied therein.

The present application is described with reference to flowchart illustrations and/or block diagrams of methods, apparatus (systems), and computer program products according to embodiments of the present application. It will be understood that each flow and/or block in the flowchart illustrations and/or block diagrams, and combinations of flows and/or blocks in the flowchart illustrations and/or block diagrams, may be implemented by computer program instructions. These computer program instructions may be provided to a processor of a general-purpose computer, special-purpose computer, embedded processor, or other programmable data processing apparatus to produce a machine, such that the instructions, which execute via the processor of the computer or other programmable data processing apparatus, create means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart flow or flows and/or block diagram block or blocks.

These computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart flow or flows and/or block diagram block or blocks.

In a typical configuration, a computing device includes one or more processors (CPUs), input/output interfaces, network interfaces, and memory.

The memory may include forms of non-permanent memory, random access memory (RAM), and/or non-volatile memory, such as read-only memory (ROM) or flash memory (flash RAM), in computer-readable media. Memory is an example of computer-readable media.

Computer-readable media includes both permanent and non-permanent, removable and non-removable media, and can be implemented by any method or technology for storage of information. Information may be computer-readable instructions, data structures, modules of a program, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other non-transmission medium that can be used to store information that can be accessed by a computing device. As defined herein, computer-readable media does not include transitory media, such as modulated data signals and carrier waves.

It should also be noted that the terms “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Without further limitation, an element defined by the phrase “including a . . . ” does not exclude the presence of additional identical elements in the process, method, article, or apparatus that comprises the element.

Those skilled in the art will appreciate that embodiments of the present application may be provided as a method, system, or computer program product. Accordingly, the present application may take the form of an entirely hardware embodiment, an entirely software embodiment, or an embodiment combining software and hardware aspects. Furthermore, the present application may take the form of a computer program product implemented on one or more computer-usable storage media (including, but not limited to, disk storage, CD-ROM, optical storage, etc.) having computer-usable program code embodied therein.

The above are only embodiments of the present application and are not intended to limit the present application. For those skilled in the art, the present application may have various modifications and changes. Any modifications, equivalent substitutions, improvements, etc. made within the spirit and principle of the present application should be included within the scope of the claims of the present application.

1. A method for detecting dark spots on an end face of an optical fiber image transmission element, comprising:
acquiring a plurality of end face images corresponding to an optical fiber image transmission element to be detected, wherein the plurality of end face images are images obtained by photographing different regions of the end face of the optical fiber image transmission element to be detected with a photographing device;
performing secondary diffusion processing on each of the end face images according to a plurality of preset diffusion matrices to generate a secondary diffusion image corresponding to each of the end face images, wherein the secondary diffusion image comprises a plurality of closed regions; and
determining a number of dark spots comprised in each of the end face images and an area value corresponding to each of the dark spots according to a number of closed regions comprised in each of the secondary diffusion images and a number of pixel points comprised in each of the closed regions.

2. The method according to claim 1, wherein the performing secondary diffusion processing on each of the end face images according to a plurality of preset diffusion matrices to generate a secondary diffusion image corresponding to each of the end face images comprises:
calculating the number of pixel points occupied by a mono fiber diameter corresponding to the optical fiber image transmission element to be detected according to the mono fiber diameter and a pixel point pitch corresponding to the end face image;
generating a target noise reduction matrix according to the number of pixel points occupied by the mono fiber diameter, selecting a first target diffusion matrix from the plurality of preset diffusion matrices according to the number of pixel points occupied by the mono fiber diameter, and selecting a second target diffusion matrix from the plurality of preset diffusion matrices;
performing convolution processing on each of the end face images with the target noise reduction matrix to obtain a noise-reduced image corresponding to each of the end face images;
performing diffusion processing on each of the noise-reduced images according to the first target diffusion matrix to obtain a primary diffusion image corresponding to each of the end face images;
performing inverse binarization processing on each of the primary diffusion images according to a plurality of preset gray thresholds to generate a target binary image corresponding to each of the end face images; and
performing diffusion processing on each of the target binary images according to the second target diffusion matrix to obtain a secondary diffusion image corresponding to each of the end face images.

3. The method according to claim 2, wherein the first target diffusion matrix comprises a central element and a plurality of elements to be diffused; and performing diffusion processing on each of the noise-reduced images according to the first target diffusion matrix to obtain a primary diffusion image corresponding to each of the end face images comprises:
performing convolution processing on the noise-reduced image with a preset two-dimensional gradient operator to obtain a gradient matrix corresponding to the noise-reduced image, wherein a plurality of pixel points in the noise-reduced image correspond one-to-one to a plurality of elements in the gradient matrix, and elements in the gradient matrix indicate gradient values of their corresponding pixel points;
dividing a maximum value among gradient values corresponding to respective elements in the gradient matrix by two to obtain a target gradient value;
determining elements in the gradient matrix having gradient values greater than the target gradient value as target elements, and determining pixel points corresponding to each of the target elements as target pixel points;
determining position coordinates of a plurality of pixel points to be diffused corresponding to each of the target pixel points according to a positional relationship between the central element and each of the elements to be diffused and position coordinates corresponding to each of the target pixel points; and
setting a gray value of each of the pixel points to be diffused in the noise-reduced image to a gray value of its corresponding target pixel point according to the position coordinates of the plurality of pixel points to be diffused corresponding to each of the target pixel points, to obtain the primary diffusion image corresponding to the end face image.

4. The method according to claim 2, wherein performing inverse binarization processing on each of the primary diffusion images according to a plurality of preset gray thresholds to generate a target binary image corresponding to each of the end face images comprises:
performing inverse binarization processing on the primary diffusion image according to the plurality of preset gray thresholds to generate a binary image corresponding to each of the preset gray thresholds;
determining the number of closed regions corresponding to each of the binary images;
calculating a difference in the number of closed regions between binary images corresponding to two adjacent preset gray thresholds;
determining, as a target gray threshold, a preset gray threshold having a smaller value among two adjacent preset gray thresholds corresponding to a maximum difference in the number of closed regions among a plurality of differences in the number of closed regions; and
determining the binary image corresponding to the target gray threshold as the target binary image corresponding to the end face image.

5. The method according to claim 2, wherein the second target diffusion matrix comprises a central element and a plurality of elements to be diffused; and the performing diffusion processing on each of the target binary images according to the second target diffusion matrix to obtain a secondary diffusion image corresponding to each of the end face images comprises:
performing convolution processing on the target binary image with a preset two-dimensional gradient operator to obtain a gradient matrix corresponding to the target binary image, wherein a plurality of pixel points in the target binary image correspond one-to-one to a plurality of elements in the gradient matrix, and elements in the gradient matrix indicate gradient values of their corresponding pixel points;
determining elements in the gradient matrix having non-zero gradient values as target elements, and determining, as target pixel points, pixel points having a gray value of zero among pixel points corresponding to the plurality of target elements;
determining position coordinates of a plurality of pixel points to be diffused corresponding to each of the target pixel points according to a positional relationship between the central element and each of the elements to be diffused and position coordinates corresponding to each of the target pixel points; and
setting a gray value of each of the pixel points to be diffused in the target binary image to zero according to the position coordinates of the plurality of pixel points to be diffused corresponding to each of the target pixel points, to obtain the secondary diffusion image corresponding to the end face image.

6. The method according to claim 1, wherein after performing secondary diffusion processing on each of the end face images according to a plurality of preset diffusion matrices to generate a secondary diffusion image corresponding to each of the end face images, the method further comprises:
performing convolution processing on each of the secondary diffusion images with a preset two-dimensional gradient operator to obtain a gradient matrix corresponding to each of the secondary diffusion images; and
performing edge processing on each of the secondary diffusion images according to the gradient matrix corresponding to each of the secondary diffusion images to obtain an edge image corresponding to each of the end face images; and
determining the number of dark spots comprised in each of the end face images and an area value corresponding to each of the dark spots according to the number of closed regions comprised in each of the secondary diffusion images and the number of pixel points comprised in each of the closed regions comprises:
determining the number of dark spots comprised in each of the end face images and an area value corresponding to each of the dark spots according to the number of closed regions comprised in each of the edge images and the number of pixel points comprised in each of the closed regions.

7. The method according to claim 1, further comprising:
determining a total area value corresponding to a plurality of first dark spots comprised in each of the end face images, and determining a number of second dark spots, a number of third dark spots, and a number of fourth dark spots comprised in each of the end face images, wherein the first dark spots are dark spots having an area value less than or equal to a first preset area threshold in the end face image, the second dark spots are dark spots having an area value greater than the first preset area threshold and less than or equal to a second preset area threshold in the end face image, the third dark spots are dark spots having an area value greater than the second preset area threshold and less than or equal to a third preset area threshold in the end face image, and the fourth dark spots are dark spots having an area value greater than the third preset area threshold in the end face image;
determining the optical fiber image transmission element to be detected as a dark spot detection failed element when the total area value corresponding to the plurality of first dark spots comprised in any one of the end face images is greater than a fourth preset area threshold;
determining the optical fiber image transmission element to be detected as a dark spot detection failed element when the number of second dark spots comprised in any one of the end face images is greater than a first quantity threshold;
determining the optical fiber image transmission element to be detected as a dark spot detection failed element when the number of third dark spots comprised in any one of the end face images is greater than a second quantity threshold; and
determining the optical fiber image transmission element to be detected as a dark spot detection failed element when the number of fourth dark spots comprised in any one of the end face images is greater than a third quantity threshold.

8. An apparatus for detecting dark spots on an end face of an optical fiber image transmission element, comprising:
an acquisition unit configured to, acquire a plurality of end face images corresponding to an optical fiber image transmission element to be detected, wherein the plurality of end face images are images obtained by photographing different regions of the end face of the optical fiber image transmission element to be detected with a photographing device;
a first processing unit configured to, perform secondary diffusion processing on each of the end face images according to a plurality of preset diffusion matrices to generate a secondary diffusion image corresponding to each of the end face images, wherein the secondary diffusion image includes a plurality of closed regions; and
a first determination unit configured to, determine the number of dark spots comprised in each of the end face images and an area value corresponding to each of the dark spots according to the number of closed regions comprised in each of the secondary diffusion images and the number of pixel points comprised in each of the closed regions.

9. A storage medium, comprising a stored program, wherein when the program is run, it controls a device in which the storage medium is located to execute the method for detecting dark spots on an end face of an optical fiber image transmission element according to claim 1.

10. An apparatus for detecting dark spots on an end face of an optical fiber image transmission element, the apparatus comprising:
a storage medium; and
one or more processors, wherein the storage medium is coupled to the processors, and the processors are configured to execute program instructions stored in the storage medium; and
when the program instructions are run, they execute the method for detecting dark spots on an end face of an optical fiber image transmission element according to claim 1.
